(19) United States
(12) Patent Application Publication
(10) Pub. No.: US 2008/0124509 A1
(43) Pub. Date: May 29, 2008

(54) Mat, and Its Corresponding Components, Pieces, Objects, Software, Kits, Devices, Material, Apparatus, System, Machines, Displays, and Accessories

(76) Inventor: Wayne Scott Boise, Bel Air, MD (US)

Correspondence Address: MAXVALUEIP CONSULTING, 11204 ALBERMYRTLE ROAD, POTOMAC, MD, 20854, US

(21) Appl. No.: 11/563,278

(22) Filed: Nov. 27, 2006

(51) Int. Cl. B32B 3/02

(52) U.S. Cl. 428/45

(57) ABSTRACT

This application discusses a mat, and its corresponding components, pieces, objects, software, kits, devices, material, apparatus, system, machines, displays, and accessories, for different applications, such as chair mat and computer mouse pad.

### BACKGROUND

Chair mats are a nearly forgotten office furniture accessory. The computer industry, for example, has transformed from a once educational, scientific, and government technological stronghold into mainstream products, found in nearly every home. This has created a booming market for products to personalize both appearance and function in the industry. Chair mats, however, have changed little, but are ripe for continuing the trend or personalizing office and personal space. Mouse pads are also good candidates. This application is applied to other similar objects, as well.

Further suggesting that the chair mat is a forgotten desk and chair accessory are recent books on designing cubicles and workspace that focus the design attention on nearly all other areas within a cubicle or desk space, except for the chair mat. A few such books are, “Pimp My Cubicle . . . ” and “Cube Chic . . . ,” as well as “The Office Space Kit.”

Prior art is mostly focused on manufacturing methods and new designs that add features to the chair mat, itself. There is no prior art for separate objects to use in conjunction with chair mats, besides the obvious chairs and casters and other furniture related products that really have nothing to do with the chair mat. Prior art also is full of features such as integrated graphics, handles, tabs, and massage foot rests that add expense and limit other uses for the product. This invention creates a new product category for objects, software, kits, devices, and retail displays for the purpose of creating and selling decorative or functional accessories for the chair mat. Prior art for chair mat graphics has focused on the mat itself instead of on accessories. Accessories enable a much less expensive alternative for manufacturing and also allow the user to change the accessory when desired. Perhaps, a user does not want a massage foot rest on the mat all the time, or perhaps, one user wants it and another user does not, at the same workstation.

Accessories can be manufactured and sold separately, with the mat, as part of a kit, or designed on software or templates, to be produced by the user, or ordered from a company. Accessories also enable the user to enhance an interior decoration theme with the chair mat. Some other examples/applications are: business, personal, holidays, sports, music, entertainment, animals, artwork, historical, licensed characters, with matching paints, trims, or fabrics, and the most lucrative market of all, the craft market.

There are some prior art, such as (US patent number, plus title):

U.S. Pat. No. 7,073,762, Detachable computer mouse pad surface in multiple sheet form,

U.S. Pat. No. 7,042,716, Ergonomic pull-out computer housing,

U.S. Pat. No. 7,040,824, Gel-cushioned accessory for a keyboard,

U.S. Pat. No. 7,025,310, Mouse rest for hand and wrist,

U.S. Pat. No. 6,971,619, Air-glide computer mouse pad having whisper surfaces,

U.S. Pat. No. 4,472,471, Chair mat,

U.S. Pat. No. 4,622,706, Air mat apparatus,

U.S. Pat. No. 4,759,543, Passive exercise cushion,

U.S. Pat. No. 4,793,012, Beach mat adapted for use on a lounge chair,

U.S. Pat. No. 4,979,375, Mat for cooling a person during hot weather without wetting having a low manufacturing cost,

U.S. Pat. No. 5,026,585, Mat for a chair,

U.S. Pat. No. 5,158,073, Acupressure foot massage mat,

U.S. Pat. No. 5,160,775, Antistatic mat,

U.S. Pat. No. 6,108,835, Camping mat arrangement,

U.S. Pat. No. 6,319,592, Decorative floor mat for use with chair,

U.S. Pat. No. 6,946,184, Desk chair mat,

U.S. Pat. No. 6,965,311, Medical alert mat with remoter pager,

U.S. Pat. No. 7,029,743, Desk chair mat.

U.S. Pat. Nos. 6,103,333, 4,415,946, 7,045,193.

US applications 20050129916, 20030024046, 20060088703, 20040254856.

Also, web sites:

Chairmats.com.

Thematstore.com.

Eldonoffice.com.

Dutchguard.com.

Staples.com.

Rolite.com.

Esrchairmats.com.

Jasco.com.

Handstands.com.

Successimage.com.

However, none of them teaches the features of the current application.

### SUMMARY

This invention discusses/teaches a mat, and its corresponding components, pieces, objects, software, kits, devices, material, apparatus, system, machines, displays, and accessories, for different applications, such as chair mat and computer mouse pad.

### BRIEF DESCRIPTION OF THE DRAWINGS

FIG. 1 shows a mat on carpet.

FIG. 2 shows a mat with a design on it.

FIG. 3 shows a mat with a handle (prior art).

FIGS. 4-8 show mats with different variations/designs/embodiments.

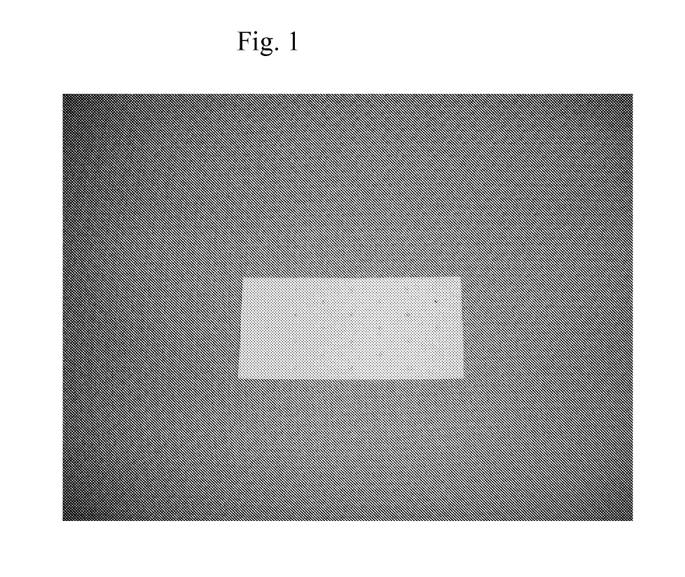

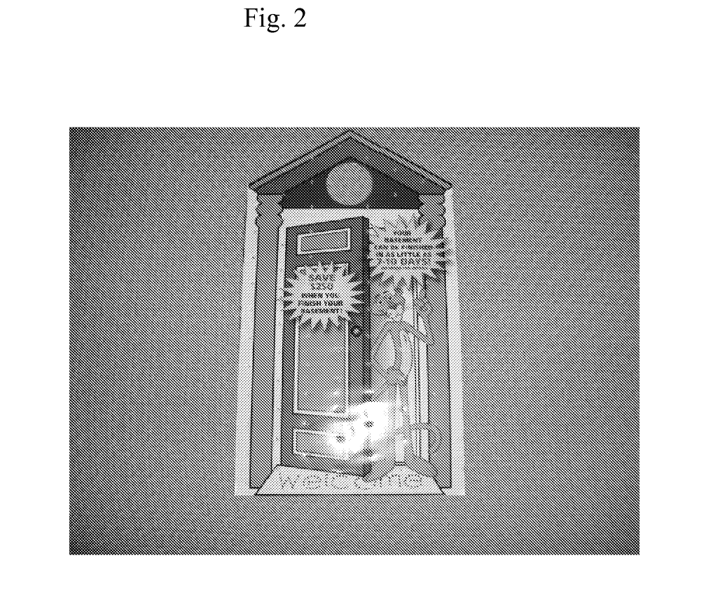

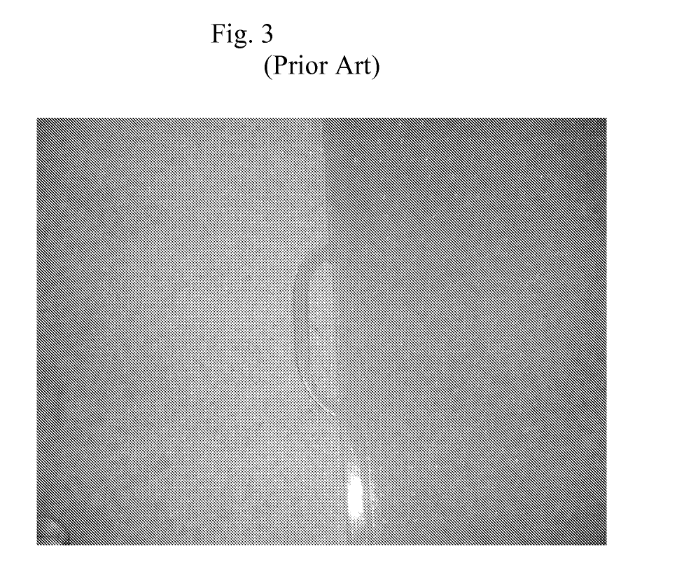

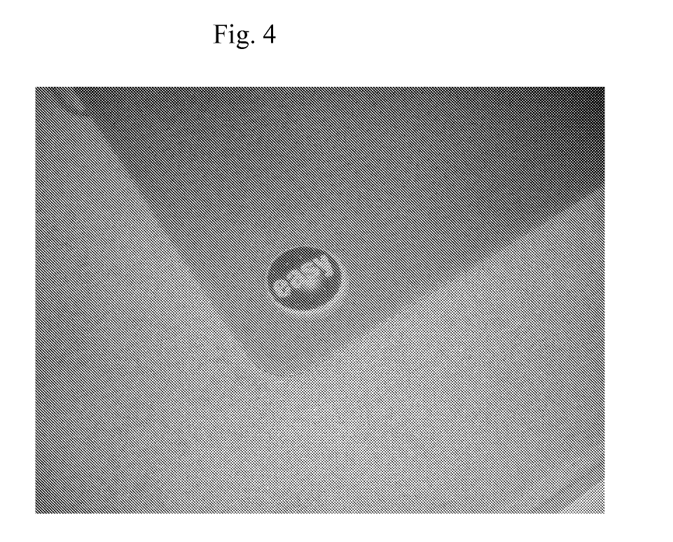

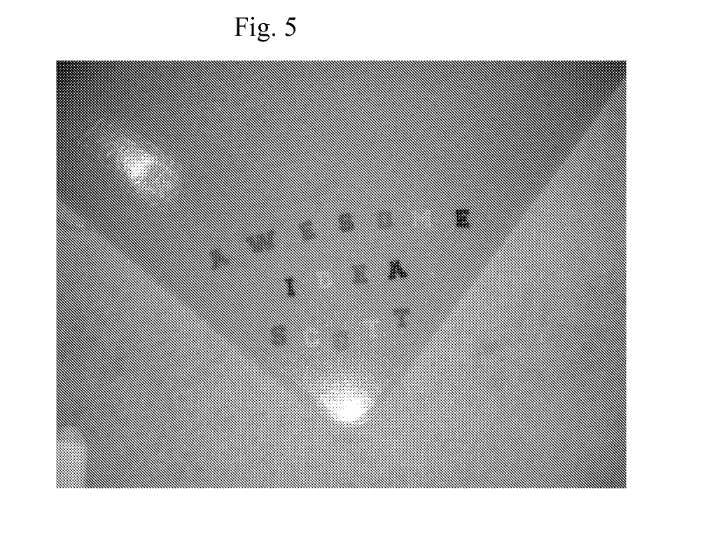

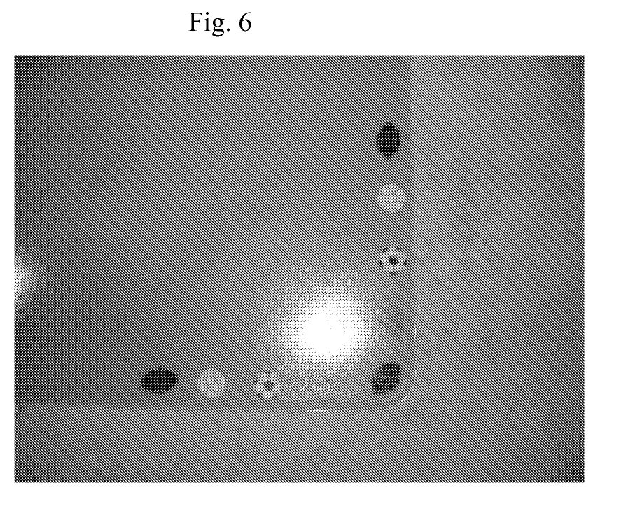

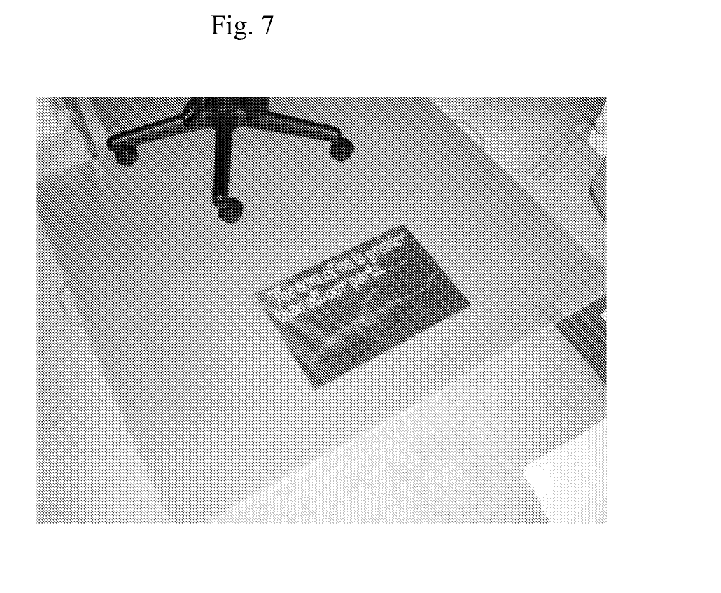

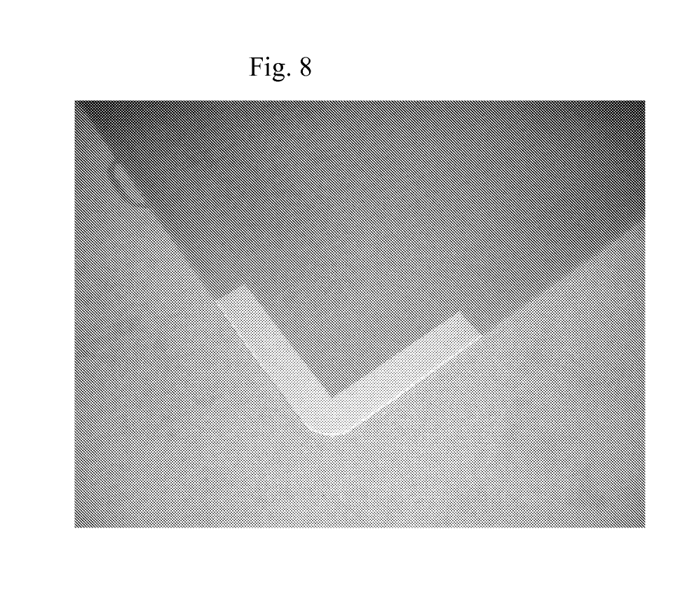

### DETAILED DESCRIPTION OF THE PREFERRED EMBODIMENTS

Prior art describes wood chair mats which are a lot more expensive. This invention also teaches (as one embodiment) that less wood could be used for borders or objects, for example, combined with a vinyl mat. It also teaches that an object could be a simulated wood grain, simulated parquet, or tile pattern, which would be interchangeable, and a lot less expensive.

Prior art has not focused on objects for chair mats that can be vertical in structure, only horizontal-based structures. The closest thing to a vertical structure is the integrated massage foot rest. A chair mat, through gravity, weight, or the use of studs, can serve as a base or positioning mechanism for an object that extends vertically above the mat. This can be useful for mats near the edge of furniture or against a wall. Examples of vertical objects could be signs, supports for computer hardware, peripherals, or sound systems, or easels. These objects could include separate parts, such as a base, an intermediary, and the vertical component, which suggests that multiple objects could attach to a standard type base design, for example. Vertical objects could create a useable space, such as a work space, or a kid's play-area or craft/painting area.

One major problem with chair mats is that the wrong style (stud size) is chosen for a particular surface, and/or mat movement occurs through use. To solve this problem, objects such as carpet grabbers can be added, stud reducer or enhancers, or even stud eliminators, for all or parts of mats. These objects may be useful when a user wants to move a mat to another room, or to make better use of an expensive industrial or graphics mat, without reordering another one for the new application.

One of the most useful objects is an object display. It can be many things, such as a frame that helps a user to place objects in a certain position under the mat. It can display one object, or assist in organizing and displaying multiple objects. One can even have a cover to protect an object from being punctured by studs. Collectibles and posters, or similar objects would benefit from this type of object display. Collectibles, such as coins or currency, baseball or other trading or playing cards, photos, stamps, pins, posters, stickers, bumper stickers, patches pennants, ticket stubs, etc. would work with this type of display.

Retailers now have a major opportunity to enhance retail displays with additional marketing materials, collect marketing information, and increase sales throughout other store departments. This invention improves existing chair mat retail displays, by adding interactive or video features, as well as, brochures and catalogs. Also, it further suggests new displays in other departments, such as in craft or drawing aisles for chair mat kits, and chair mat software in the computer section (and perforated or sized notes or paper for those aisles). As an added benefit, the display technology can be used for other products, or integrated into an overall system. Retailers can develop promotions for mats that may or may not include products in other departments that are related to the mat or accessories, or which may suggest a more comprehensive promotion for office furniture or chairs, for example. It gets consumers thinking about chair mat features and benefits, which create an opportunity to sell not only a higher dollar value product, but also for other products on the original purchase date and the future dates. Simply put, this invention encompasses an entire family of products throughout the office supply store, with multiple industries represented, and it will generate additional sales, as users update or change accessories over time, and even buy mats on a more frequent basis.

An object is limited by the strength of the mat and the durability of the product, given the pressure of the chair and the user and other factors, such as foot traffic (and even simultaneous multiple users, or forceful events, such as an accidental dropping of a heavy object). Products with inherent flexibility will work better with this process, such as paper-based products and sponge or foam-based products, or any type of textile or leather. Also, certain plastic and vinyl products or adhesive products will perform well as a chair mat object. It is also important how the object is attached, such as by adhesive (or without adhesive) and the density and resistance of the surface beneath the mat.

In general, on a carpeted or flat surface, the mat provides adequate protection for a large variety of objects, as it deflects much of the pressure exerted on it or transfers it to the absorbing power of the surface it protects.

An object's effectiveness is also limited by the height of the studs or the depth of the carpet. However, most carpet surfaces will mat down sufficiently for a broad range of objects to be installed under a chair mat without adversely affecting the level plane of the mat and, thus, the effect on the user is negligible, if any at all. Objects will also be limited by the color and the ability to be seen through the chair mat. Most objects can be seen well through the mat, but more vibrant colors and patterns will fare better. Certainly, objects not made specifically for the mat may be used, and may work well, but, perhaps, spatial dynamics are a factor in that the studs may block out important aspects of the object and reduce the desired visual impact (or may not be in the proper position). Objects made for the mat may undergo embossing or other production processes designed to reflect back more visible light and color or, to the contrary, reduce glare, whichever is more beneficial for the user's environment. Many of the fundamentals of physics apply, and objects have ratings for areas to be used, and what minimum and maximums are required.

Some of the biggest applications are going to be for craft kits. One of the best products on the market that will work with this invention is a foam-based product called Foamies. It is hundreds of different types of foam cut outs in various letters, numbers, shapes, and colors. There are even many functional products made with it, such as picture frames.

A few craft websites (but still not teaching our invention):
www.janlynn.com
www.pepperell.com
www.darice.com
www.crayola.com

Other applications and examples:
floor mats, desk mats, mouse pads, computer hardware or peripherals, office furniture products, barbershop/salon mats. Other features are:
   Perforated (air flow mat) or non-perforated, or a combination of
   Residential, commercial, or industrial
   Textured or non-textured, or a combination of, on top or bottom, or both or combinations
   Anti-static or non-anti-static
   Studded or non-studded, or a combination of
   Plastic, vinyl, wood, carpet, or a combination of
   Colored, clear, or a combination of
   Standard sizes or custom orders, including custom shapes or multiple products
   Beveled or non-beveled edges, or crystal edges, or a combination of
   Graphics manufactured mats, such as by Rolite
   Handle(s) or mats without a handle
   Hang tabs or mats without a hang tab
   Folding or non-folding mats
   Compatible with any type of retail display
   Etched or non-etched
   For any thickness of carpet or flat surface, or a combination of
   For any stud pattern, such as square, offset, designs, or a combination of
   Interlocking mats and areas
   Massage foot rest mats
   Carpeted or partially carpeted
   With or without a backing
   No-crack
an anti-static cord.
An object may be horizontal or vertical, or a combination.
Any object under a mat that is not a retail sticker. It can be perforated or not perforated, or partially perforated.
Any object over or on a mat that is not a retail sticker.
Any object partially over or under, or a combination, or beside, that is not a retail sticker.
An object can be a stud that is removable, or different colors and part of a stud design kit.
Accessories can be any material such as paper, paperboard, poster board, cardboard, metal, vinyl, wood, leather, photos, plastic, labels, stickers, or fabrics.
Paper or self-stick notes, which can be sold pre-perforated, to fit a specific manufacturer's stud pattern, or made non-perforated to fit the stud pattern in various shapes and other combinations.
An object can be a handle or tab, that is integral or not integral to the mat. It attaches or folds or recesses or inserts into the mat. (No need to cut it off, and can be made thinner, possibly. Can even be perforated to work with existing mat studs.)
An object can be a sticker or other label that tells the user to “Cut Here” for removing a handle.
An object in the mat could be a groove to make cutting the handle or tab easier.
An object could be a handle or storage tab that is sold with, or added later by the user.
Objects can glow in the dark, or be electronic, biological, or heat sensitive.
An object can be man-made, natural, or a combination.
An object can be a storage or security area, either transparent or non-transparent.
Objects can extend beyond a chair mat perimeter.
Objects can be an intermediary connector to add a chair mat extension, to increase covered space.
An object can be a chair mat extension.
An object can be inserted partially into a mat, or fully or recessed or threaded or a combination.
An object can be an adhesive or hook and loop fastener, to secure mats to an area.
An object could be another mat or rug.
An object could be inside of the mat.
An object could be a massage foot rest that attaches and detaches from the mat.
An object could be a solid, a liquid, or a gas, or a combination.
An object could be a cord organizer.
An object can be sold already installed on the mat, or sold with the mat, requiring user installation, or sold separately.
Objects can be reversible or not.
Objects could be multi-layered or not.
Objects can fold, telescopic, adjust, split, or not.
Objects can interconnect or overlap, or not.
Objects can be a puzzle or a game, or other types of activity.
The mat can be comprised of multiple objects that connect together or use connectors.
The mat may or may not have slots, holes, or recessed areas, on the top or bottom or side or sides.
Objects may go through, or partially through, the chair mat, or a combination.
Objects may attach/detach by any means, such as staples or heat seal.
Objects may include one or more letters, numbers, symbols, shapes, etc.
An object may have transparent or translucent qualities in all or part.
An object may be one color or a combination of colors.
Objects may or may not be designed specifically for each manufacturer's stud placement. For example, perforated printer paper or photo paper, or notes, calendars, labels, etc.
An object may have reverse adhesive, such as that of a sticker to be viewable through the mat.
An object can have frames or guides, or groups of those, or other combinations, to display or sort or organize an object or group of objects, with the studs or with the mat.
The object display may or may not have a cover.
An object can be inflexible or flexible or stretch or not stretch.
An object can have heating or cooling properties such as a heating pad or hand warmer.
An object can be an input device either manual or electronic such as a foot pad, keypad, or keyboard, which may be helpful for disabled people, or a pedal or other apparatus for gaming applications. The mat may help to secure or hold these objects or serve as all or part of the base.
An object can be a cover or a slip cover or part of.
An object can be studded or partially studded or grooved or notched to fit existing or new mat designs.
An object may be a sign or directional arrows or instructions. Example, a handicapped symbol for an accessible workstation or an arrow indicating the direction to the nearest exit.
An object's edges may be trimmed, expanded, contracted, or marked for such possibilities.
An object may be a stud blocker to cover areas of studs.
An object maybe holes or plugs to go in a mat after it has been modified in order to decorate or to restore it to its original state.
Objects could be chair mat-related, sayings for example: “Here Sits . . . ” (Sayings, slogans, and other serious or comical words could be used.)
An object display can be perforated or not, or its cover may be perforated or not.
An object display may set within studs or not.
An object could be an air freshener that is perforated or not, and/or used with a venting mat or not.
An object can simulate wood grain or wood trim. Basically, for decorative purposes or to serve as a less expensive alternative to hardwood mats.
An object connector can be used for one stud on each mat or object, or more than one, or be used along part or the whole lengths, be of varying depths, and be trimmed, etc.
An object could be a chair mat stud leveler, reducer, adder, or even pattern changer.
An object may be magnetic.
An object could be a mirror or have reflective properties, or be a reflector.
An object could be a professional license or a certificate.
An object can be a border extension.
An object can be a peg board or reverse of the stud idea.
A vertical object can fold down or rotate or adjust.
Studs can be used for loop, string, lacing, or other designs. Also, templates and kits can be developed to provide users material and designs. New studs can be added, studs modified, or notched (or stud add-ons with relevant features such as a notch or area for the craft material, etc.).
An object could be craft supplies, party supplies, pet supplies, or products for home or office or industry.
An object can be a mat hook or a mat picture hanger. Mats can be hung from the wall or ceiling or post or beams or stand, etc., and displayed with or without other mat objects.
Objects or kits can be sold with decorating or design books for offices, etc.
An object can also be rubber-based.
An object or a mat can be sold with a theme or themes of objects.
An object can be sand or sand designs.
An object can be Astroturf or outdoor rugs or outdoor carpeting.
An object can be a measuring device, such as for measuring children's feet or height.

Kits and Devices to Create Objects or Modify Mats:
Anything sold with a chair mat.
Kits can be sold separately.
A kit can be used to create objects, sell pre-made objects, or a combination.
Can include drawing instruments, paints, stickers, cutting and measuring instruments, etc., to make the object.
The kit can include software, manuals, videos or audios, templates, etc.
The kit can include a manual or electronic stud producing device and/or a device that creates the stud pattern on other objects, such as a paper press.
The kit can have a mat punch that inserts handles or tabs, if the user desires. It can be like a hole punch, and designed to do most anything, such as create holes, to add threaded beads or rope, etc.
A device can also be for creating recessed or notched areas on a mat or accessory.
A device can be a stud cutter and/or stud size adjuster and/or a stud notch adjuster.
A device can be an object roller that firmly secures an object to a mat.
Kits can have objects such as electronic components: lights or speakers or receivers or LCD or other displays or power cords and/or devices, to modify chair mats to use with wires/batteries/bulbs, etc. Kits can also have objects to guide or store the components, or vent them, or otherwise enable usage.
Kits can have a border for keeping a chair within the perimeter of the mat.
Kits can be for chair mat extensions including templates and cutting materials and connectors.
Kits can include a means for temporary or permanent attachment for accessories to a mat.
A kit or kits can be sold with a mat.
A kit may include a laminating device, vinyl cover, sheet protector, or other protection for the object.
A kit may include an etching or engraving device.
A kit may include carpet grippers or other positioning or connecting devices.
A kit may be for horizontal or vertical objects.
A kit may be for an object display or displays, and may or may not include the object(s) to put in the display(s). It may or may not include a cover.
A device could be used for burning images, or burning a hole a certain depth, to insert an object partially or fully into the mat.
A kit can be for cubicle or office design, and for interior decorators and commercial or industrial designers.
A chair and a chair mat together can be a kit.

Displays and Retail:
Video and audio and interactive displays and displays for kits, too. Basically, enhancing chair mat retail displays by making them marketing friendly. Example: a product demo integrated into the display, or beside it, or part of a POS display for kits, or beside it, etc.
The above video or interactive display can also include the store catalog and/or information on office furniture, chairs, and casters, etc, which often are in the same place in the store.
The display can be used to place an order for anything, or develop a custom order, or to call for assistance from a sales professional.
Perforated retail display on or for the mat itself, or for other products.
An object can be a features page, warranty page, promotion, order form for kits or accessories or software, a catalog, and/or registration card, perforated or not, on or partially on, or around the mat.
A display with the above attached for users to take off and read.
A display with mats and kits together, or an object or software, etc. Or, separate displays next to each other, or near each other.
Any retail display with electronic power or systems, and/or a touchpad, button, keyboard, audio or speaker, video or display, or other marketing objects, as suggested above.
Any of the display components can be added to existing displays, or built with new displays.

Software and Other Media (Electronic or Not):
Software can be already installed on personal computers through a license with a computer manufacturer, or sold at retail, or downloaded from the Internet.
User-designable chair mat accessories, and/or for other accessories, such as for mouse pads.
Electronic media, such as software and videos, with how-to instructions, design layouts, etc.
Software or other ‘online’ ordering materials for selecting, measuring, designing, etc.
Anything can be scanned or adjusted by software, printed out, or otherwise produced and installed.
Software for manufacturing the products and the machines and die cutters, etc for the manufacturer.
Software and larger templates for the printing and photo industry, as well as the retail displays, etc.
Media for training sales professionals.
Can be integrated with other office-related software products or suites, such as word processing or graphics of publishing software, or part of a printer software package.
Software can be programmed and updated periodically with new manufacturer specs on stud placement to optimize object printout and to work with newly developed objects or object medium.
Software can be for online downloads, or ordering of designs or kits.

Base or Platform Object
An object can be a base or platform that extends the height of the chair mat, or increases its physical strength properties, or accessabilities. This may have adjustable features on it, for height or for studs. It may have edge extensions or padding to prevent injury, or to enable transition from chair mat to the surface below it. It may have curbing, to prevent chairs from going off of it.
The above type of object allows for non-flat items to be placed under the mat. Even live animals, fish, and plants could be placed in special tanks or aquariums designed for this purpose.
The base or platform can have special reinforcements in it.
It more easily allows for electronic components to be installed and used.
It can encompass a display and/or storage area and multiple compartments.
It can have a mechanism(s) to adjust the objects displayed, meaning to make one or more objects viewable that were previously hidden.
A base or platform may necessitate changing the height of the existing chair or the furniture to compensate, and may be unsuited for some applications. It also may allow for the creation of unique work or play stations for young children that are well-off of the floor surface, but seated at the proper height for use of the desk.

### Other Applications/Usages/Examples/Variations/Embodiments:

is used as a mouse pad,
is small desk-top version,
has wheel(s) on the side or underneath,
is flexible,
is rigid,
is molded according to pressure points, such as pressure caused by chair legs,
has two or more layers with liquid, gas, air, gel, solid, or mixture in between,
has multiple layers, capable of pumping liquid, gas, air, gel, solid, or mixture in between, using a manual or electric pump,
is made of plastic,
is made of rubber,
is made of glass,
is made of quartz,
is made of crystal,
is made of array of solar cells,
is made of stones,
is made of granite,
is made of carpet,
is made of synthetic material,
is made of natural material,
is made of wool,
is made of cotton,
is made of silk,
is made of nylon,
has a handle,
has spikes on the bottom for better grip to the carpet,
has Velcro on the bottom for better grip to the carpet,
has glue or tape on the bottom for better grip to the carpet,
has belt or chain for better grip/connection to the furniture or fixed building fixtures,
has a flat smooth surface on the bottom for better grip to the hardwood, stone, or tile floors,
has patches at the edges or in middle, for grip, or as short legs,
has legs,
has spring-loaded legs,
has adjustable legs,
has removable legs,
has hydraulic-adjustable-height legs,
has smooth top surface,
has rough top surface,
has curved edges,
has concave top and/or bottom surfaces,
has convex top and/or bottom surfaces,
can be folded,
can be stored,
can be stretched,
can be returned to its original shape,
can absorb water or liquid,
has a heater element in it,
has an electrical plug in it,
has a computer network, TV, or cable connector in it,
has lights in it,
has Christmas decoration in it,
has light reflective material in it,
has watermark in it,
has a flat screen TV or computer monitor under it,
has two or more pictures, each visible in different angles, under it,
has a Fresnel-type lenses in it,
has a magnifier in it,
has a aquarium under it,
has a cage under it,
has a register for HVAC system connected to it,
has a medical alert connected to ADT or similar services,
has a security feature/alarm,
is secured to another or with another equipment or furniture,
is transparent,
is translucent,
is opaque,
is transparent for infrared,
is used for chair,
is used for camping,
is used in cars, as a mat,
is used for acupressure foot massage,
is an antistatic mat,
has a static discharge wire, connected to a metal item or other objects,
has a cooling elements,
has a fan,
has circulating water,
has circulating liquid or gas,
has a pump,
has an ergonomic design,
fits the curvatures of feet,
supports the feet,
molds according to shoe or feet,
is a gel-cushioned accessory for a keyboard,
is a mouse rest for hand and wrist,
has an air-glide surface,
is an air mat,
is an exercise cushion,
has pictures shown under it,
has movies shown under it,
plays music or radio, with speakers attached or separate,
has pictures customized or ordered,
has pictures slide in or out,
has a frame under it,
has the decoration or picture interchangeable or replaced,
has adjustable lights,
has flashing lights,
has dimmers for lights,
has light color changes gradually, under it,
has edges,
has customized pictures in it,
has customized shape,
has texture,
has logo,
used for advertisement,
has text or alphabet pieces under it,
can be used as a spelling game for kids,
can be used as a board,
can be used as a writing board,
has magnet or metal in it, to attach to or hold magnetic pieces, objects, or figurines, as a game or for decoration,
has sports symbols in it or attached to it,
has baseball cards, coins, comic books or figures, collectibles, or stamps, inserted in the sleeve(s) underneath,
has a tilted structure,
has an angled structure,
sold/distributed/displayed as a kit,
sold as one piece,
sold in multiple pieces,
sold as a jig saw puzzle structure,
sold as simple blocks/components/tiles with groves to hook/lock to each other, to build the whole thing,
any software that controls the motor or movable parts mentioned above,
displays movable pictures, non-static,
displays movies,
displays movable objects,
displays digital information,
displays repeated patterns,
displays tessellation patterns,
has a handle with perforations,
has a border,
has spots or border or along the edge,
has a lid or cover.

Other Features or Components/Variations are:
laminate, Corian, table mat, desk mat, floor mat, bath mat, automotive mat, exercise mat or pad, computer mat, advertising mat, logo mat, calendar mat, gaming gears, pedals, steering wheel, and joystick.

The pictures or objects can also be put on the top of the mat, and they are thread-resistant.

Any variation of the above is also covered and intended to be protected by the current patent.

1. A mat or pad system, said system comprising:
a mat or pad surface; and
a display means.

2. A system as recited in claim 1, wherein said system comprises one or more borders or edges.

3. A system as recited in claim 1, wherein said system comprises one or more of the following materials: vinyl, simulated wood grain, foam, gel, simulated parquet, paper, paperboard, poster board, cardboard, metal, wood, leather, plastic, elastic material, rubber, wool, cotton, glass, laminate, Corian, silk, carpet, man-made, solid, liquid, gas, multi-layered, alloy, mixture, inflexible, flexible, stretchable, non-stretchable, wood grain, wood trim, hardwood, Astroturf, outdoor rugs, outdoor carpeting, textured, glass, quartz, crystal, array of solar cells, stones, granite, carpet, synthetic material, natural material, nylon, or fabrics.

4. A system as recited in claim 1, wherein said system comprises interchangeable tiles, components, pictures, colors, tile patterns, designs, or frames.

5. A system as recited in claim 1, wherein said system comprises one or more of the followings: studs, base, support for signs, perpendicular or vertical signs, objects, or displays, support for computer hardware, peripherals, or sound systems, or easels.

6. A system as recited in claim 1, wherein said system comprises one or more of the followings: massage foot rest, play area, or work area.

7. A system as recited in claim 1, wherein said system is used as one or more of the followings: a chair mat, a mouse pad, a welcome mat, door mat, decoration, display, table mat, desk mat, floor mat, bath mat, automotive mat, exercise mat or pad, computer mat, advertising mat, logo mat, calendar mat, or general purpose mat.

8. A system as recited in claim 1, wherein said system displays one or more of the followings: objects, pictures, movies, slides, or movable objects or pictures.

9. A system as recited in claim 1, wherein said system comprises one or more of the followings: cover, wheel, pump, gaming gears, pedals, steering wheel, joystick, label, sticker, or electrical plug.

10. A system as recited in claim 1, wherein said system comprises one or more of the followings: collectibles, dolls, stuffed animals, model cars, models, trains, moving trains, coins, currency, sports or baseball cards, trading items, playing cards, photos, stamps, pins, posters, stickers, bumper stickers, patches pennants, or ticket stubs.

11. A system as recited in claim 1, wherein said system or parts of said system is used in retail display or chair mat display.

12. A system as recited in claim 1, wherein said system or parts of said system is sold, distributed, or displayed as a kit, as a packaged item, OEM package, or a bundled product or products.

13. A system as recited in claim 1, wherein said system's components are sold, distributed, or displayed separately or individually.

14. A system as recited in claim 1, wherein said system's components are sold, distributed, or displayed in one package.

15. A system as recited in claim 1, wherein said system's components are sold, distributed, or displayed with brochures, help products, training products, manuals, video, software, or information package.

16. A system as recited in claim 1, wherein said system's components are put together by a consumer or user.

17. A system as recited in claim 1, wherein said system's components are locked or attached to each other.

18. A system as recited in claim 1, wherein said system comprises a perforated mat.

19. A system as recited in claim 1, wherein said system comprises a non-perforated mat.

20. A system as recited in claim 1, wherein said system comprises an air flow mat.

21. A system as recited in claim 1, wherein said system is used in residential, commercial, indoor, outdoor, or industrial settings.

22. A system as recited in claim 1, wherein said system comprises one or more of the following materials, properties, or components: textured, non-textured, thread-resistant, anti-static, non-anti-static, studded, non-studded, colored, clear, beveled edges, non-beveled edges, crystal edges, with handle, with hang tab, integrated, non-integrated, folding, non-folding, etched, non-etched, flat surface, interlocking, with massage foot rest, with backing, without backing, adhesive, hook and loop fastener, cord organizer, or with anti-static cord.

23. A system as recited in claim 1, wherein said system comprises one or more of the following materials or components: with moving parts, glowing in the dark, electronic, biological, or heat sensitive.

24. A system as recited in claim 1, wherein said system does one or more of the followings: secures a mat to an area, object, fixture, wall, house, or furniture, secures to another mat, or attaches to the mat.

25. A system as recited in claim 1, wherein said system's shape or structure comprises one or more of the followings: foldable, telescopic, adjustable, split, rotating, suspended, floating, horizontal, diagonal, or vertical.

26. A system as recited in claim 1, wherein said system comprises one or more of the followings: puzzle, a game, any types of activity, multiple objects that connect together or use connectors, have slots, holes, or recessed areas, on the top, bottom, side, or sides, include one or more letters, numbers, symbols, or shapes, grooved or notched to fit existing or new mat designs, or has a sign or directional arrow.

27. A system as recited in claim 1, wherein said system is used for loop, string, lacing, or other designs.

28. A system as recited in claim 1, wherein said system comprises staples, connecting means, chain, glue, tape, chain, band, adhesive, reverse adhesive, means for temporary or permanent attachment for accessories to a mat, carpet grippers, positioning or connecting devices, mat hook, mat picture hanger, or heat seal.

29. A system as recited in claim 1, wherein said system is partially or fully transparent, translucent, opaque, or with one or more colors.

30. A system as recited in claim 1, wherein said system comprises one or more of the followings: frames, guides, or studs.

31. A system as recited in claim 1, wherein said system comprises one or more of the followings: heating or cooling devices, a heating pad, hand warmer, air freshener, foot warmer, dispersal system using liquid, gas, solid, or mixture, dehumidifier, humidifier, fog machine, smoke machine, bubble machine, aromatic devices, or venting device.

32. A system as recited in claim 1, wherein said system comprises one or more of the followings: input device, networking and gaming devices, manual or electronic device, foot pad, keypad, or keyboard.

33. A system as recited in claim 1, wherein said system comprises one or more edges which are trimmed, expanded, folded, contracted, or marked for such possibilities.

34. A system as recited in claim 1, wherein said system comprises one or more of the followings: holes or plugs to go in a mat after it has been modified in order to decorate, restore it to its original state, or repair it.

35. A system as recited in claim 1, wherein said system comprises one or more of the followings: chair mat stud leveler, reducer, adder, or pattern changer.

36. A system as recited in claim 1, wherein said system comprises one or more of the followings: magnetic, mirror, have reflective properties, reflector, roller, or wheel.

37. A system as recited in claim 1, wherein said system comprises one or more of professional documents, licenses, plaques, diplomas, awards, or certificates.

38. A system as recited in claim 1, wherein said system comprises one or more of the followings: border extension, peg board, or reverse of the stud.

39. A system as recited in claim 1, wherein said system comprises one or more of the followings: templates added, or studs modified or notched.

40. A system as recited in claim 1, wherein said system is displayed or sold by or with craft supplies, party supplies, pet supplies, toy store, automotive supplies, or products and supplies for home, office, or industry.

41. A system as recited in claim 1, wherein said system comprises one or more of the followings: drawing instruments, paints, adhesives, stickers, cutting and measuring instruments, software, manuals, videos or audios, or templates.

42. A system as recited in claim 1, wherein said system comprises one or more of the followings: a manual or electronic stud producing device, a device that creates the stud pattern on other objects, a paper press, stud cutter, stud size adjuster, or stud notch adjuster.

43. A system as recited in claim 1, wherein said system comprises one or more of the followings: mat punch for inserting handles or tabs, hole punch, threaded beads or rope, means for threading, or create recessed or notched areas on a mat or accessory.

44. A system as recited in claim 1, wherein said system comprises one or more of the followings: electronic components, lights, paper shredder, trash can, speakers, receivers, LCD, displays, power cords, wires, batteries, bulbs, guide, storage for the components, or vent.

45. A system as recited in claim 1, wherein said system comprises a border, curb, padding, recessed area, stepped platform or area, or device for keeping a chair within the perimeter.

46. A system as recited in claim 1, wherein said system comprises a chair mat extension, with templates and cutting materials and connectors.

47. A system as recited in claim 1, wherein said system comprises one or more of the followings: laminating device, vinyl cover, sheet protector, or other protection.

48. A system as recited in claim 1, wherein said system comprises one or more of etching, embossing, or engraving devices.

49. A system as recited in claim 1, wherein said system comprises one or more of the followings: burning images or burning a hole in a certain depth, to insert an object partially or fully into a mat.

50. A system as recited in claim 1, wherein said system is used for cubicle, office design, interior decorators, house planning, cabinetry design, or commercial or industrial designers.

51. A system as recited in claim 1, wherein said system comprises one or more of the followings: display, software, video, or instructions.

52. A system as recited in claim 1, wherein said system or its components are sold by one or more of the followings: online downloads or ordering of designs or kits, or retail ordering or assistance system.

53. A system as recited in claim 1, wherein said system comprises measuring device, scale, or measuring device for children's or people's feet, hand, weight, or height.

54. A system as recited in claim 1, wherein said system comprises one or more of bases or platforms that extend, raise, or lower the height of the chair mat.

55. A system as recited in claim 1, wherein said system comprises one or more of the followings: live animals, fish, ants, insects, reptiles, amphibians, or plants placed in cage, tanks, or aquariums.

56. A system as recited in claim 1, wherein said system is used as a mouse pad or desk-top version.

57. A system as recited in claim 1, wherein said system is flexible, rigid, or molded according to pressure points.

58. A system as recited in claim 1, wherein said system has two or more layers with liquid, gas, air, gel, solid, or mixture in between.

59. A system as recited in claim 1, wherein said system comprises a manual or electric pump to pump liquid, gas, air, gel, solid, or mixture in between layers or jackets.

60. A system as recited in claim 1, wherein said system comprises one or more of the followings: handle, spikes on the bottom for better grip to the carpet, Velcro on the bottom for better grip to the carpet, hook and loop fastener, glue or tape on the bottom for better grip to the carpet, belt or chain for better grip to the furniture or fixed building fixtures, flat smooth surface on the bottom for better grip to the hardwood, stone, vinyl, or tile floors, patches at the edges or in middle, legs, spring-loaded legs, adjustable legs, removable legs, hydraulic-adjustable-height legs, smooth top surface, rough top surface, curved edges, concave top and/or bottom surfaces, or convex top and/or bottom surfaces.

61. A system as recited in claim 1, wherein said system has one or more of the following properties: be stretched, be returned to its original shape, or absorb water or liquid.

62. A system as recited in claim 1, wherein said system comprises one or more of the followings: a heater element, an electrical plug, antenna, satellite dish, a computer network, TV or cable connector, or lights.

63. A system as recited in claim 1, wherein said system comprises one or more of the followings: light reflective material or watermark.

64. A system as recited in claim 1, wherein said system comprises one or more of the followings: flat screen TV or computer monitor.

65. A system as recited in claim 1, wherein said system comprises one or more pictures, each visible in different angles.

66. A system as recited in claim 1, wherein said system comprises one or more of the followings: Fresnel-type lenses or magnifier.

67. A system as recited in claim 1, wherein said system comprises one or more of the followings: an aquarium or a cage underneath said system.

68. A system as recited in claim 1, wherein said system comprises one or more of the followings: HVAC system, medical alert, security alarm, cooling elements, circulating water, fan, circulating liquid or gas, or pump.

69. A system as recited in claim 1, wherein said system comprises one or more of the followings: transparent, translucent, opaque, or transparent for infrared.

70. A system as recited in claim 1, wherein said system is used for chair, camping, in cars, as a mat, acupressure foot massage, ergonomic design, molds according to shoe or feet, gel-cushioned, air-glide surface, air mat, or exercise cushion.

71. A system as recited in claim 1, wherein said system comprises one or more antistatic devices or static discharge wires.

72. A system as recited in claim 1, wherein said system comprises one or more of the followings: static pictures, movable pictures, non-static items, movies, movable objects, digital information, repeated patterns, tessellation patterns, or multimedia game, shown underneath.

73. A system as recited in claim 1, wherein said system plays or records music, comprises a radio, or uses a recording media.

74. A system as recited in claim 1, wherein said system comprises one or more pictures sliding in or out, with a frame.

75. A system as recited in claim 1, wherein said system comprises one or more of the followings: adjustable lights, flashing lights, strobe lights, moving or rotating lights, or dimmers for lights.

76. A system as recited in claim 1, wherein said system comprises gradual light color changes.

77. A system as recited in claim 1, wherein said system comprises one or more of the followings: logo, advertisement, text or alphabet pieces, spelling game, board, or writing board.

78. A system as recited in claim 1, wherein said system comprises one or more sport symbols inside or attached to said system.

79. A system as recited in claim 1, wherein said system comprises one or more of the followings: baseball cards, coins, comic books or figures, collectibles, items, objects, or stamps, inserted in a sleeve or frame.

80. A system as recited in claim 1, wherein said system comprises one or more of the followings: a tilted structure, an angled structure, jig saw puzzle structure, simple blocks, components, or tiles with means to hook or lock to each other.

81. A system as recited in claim 1, wherein said system comprises software that controls the motor or movable parts.

82. A system as recited in claim 1, wherein said system comprises a storage means, or a kit for making a storage unit.

83. A system as recited in claim 1, wherein said system or pieces of said system are stored in a storage bin or an organizer.

84. A system as recited in claim 1, wherein said system is fitted, in coordination with, or matched with the furniture, parts of the house, fixtures, or objects in the house, office, or building.

85. A system as recited in claim 1, wherein said system comprises a hidden camera, camera, security system, sound recording system, safe, or locker.
